(19) United States
(12) Patent Application Publication
(10) Pub. No.: US 2019/0176956 A1
(43) Pub. Date: Jun. 13, 2019

(54) DETACHABLE MULTIAXIAL AIRCRAFT

(71) Applicant: HON HAI PRECISION INDUSTRY CO., LTD., New Taipei (TW)

(72) Inventor: HAN-XUN CHEN, New Taipei (TW)

(21) Appl. No.: 15/884,411

(22) Filed: Jan. 31, 2018

(30) Foreign Application Priority Data
Dec. 8, 2017 (TW) 106143284

(51) Int. Cl. B64C 1/00; B64D 35/02; B64C 39/02; B64C 27/20

(52) U.S. Cl. CPC B64C 1/00; B64D 35/02; B64C 39/024; B64C 2201/042; B64C 2201/027; B64C 2201/108; B64C 27/20

(57) ABSTRACT

A detachable multiaxial aircraft is related. The aircraft includes a fuselage and a number of lift arm assemblies. The lift arm assembly includes a landing chassis, an electric motor mounted on the landing chassis, and a propeller fixed on the electric motor. The lift arm assembly further includes a shell located on the landing chassis and surrounding the propeller. The fuselage includes a first connector, and the shell includes a second connector. The lift arm assembly is detachably connected to the fuselage by the first connector and the second connector.

### CROSS-REFERENCE TO RELATED APPLICATIONS

This application claims all benefits accruing under 35 U.S.C. § 119 from Taiwan Patent Application No. 106143284, filed on Dec. 8, 2017, in the Taiwan Intellectual Property Office, the contents of which are hereby incorporated by reference.

### BACKGROUND

### 1. Technical Field

The present disclosure relates to aircraft technology, and particularly, to a detachable multiaxial aircraft.

### 2. Description of Related Art

A multiaxial aircraft, typically, is a one-piece device that is integrated with different components, e.g. the fuselage and the lift arm assemblies. It is not convenient to repair and carry around the multiaxial aircraft.

A published Chinese patent application with a publication number CN204548489U disclosed a detachable multiaxial aircraft, where the fuselage and the lift arm assemblies are locked or unlocked with each other by a locking element, and electrically connected with each other at the locking position. The lift arm assembly includes a rotary wing and a rotary arm. The rotary arm is detachably locked or unlocked to the fuselage. The rotary arm, however, does not have any protection and is easy to break.

What is needed, therefore, is to provide a detachable multiaxial aircraft that can overcome the problems as discussed above.

### BRIEF DESCRIPTION OF THE DRAWINGS

Many aspects of the exemplary embodiments can be better understood with reference to the following drawings. The components in the drawings are not necessarily drawn to scale, the emphasis instead being placed upon clearly illustrating the principles of the exemplary embodiments. Moreover, in the drawings, like reference numerals designate corresponding parts throughout the several views.

FIG. 1 is a schematic view of a first exemplary embodiment of a detachable multiaxial aircraft.

FIG. 2 is a schematic view of a first exemplary embodiment of a fuselage.

FIG. 3 is a schematic view of a first exemplary embodiment of another fuselage.

FIG. 4 is a top main view of a first exemplary embodiment of a lift arm assembly.

FIG. 5 is a top view of a first exemplary embodiment of the lift arm assembly.

FIG. 6 is a bottom main view of a first exemplary embodiment of the lift arm assembly.

FIG. 7 is a side view of a first exemplary embodiment of the lift arm assembly.

FIG. 8 is a schematic view of a second exemplary embodiment of a detachable multiaxial aircraft.

FIG. 9 is a schematic view of a third exemplary embodiment of a detachable multiaxial aircraft.

FIG. 10 is a top view of a third exemplary embodiment of the detachable multiaxial aircraft.

FIG. 11 is a side view of a third exemplary embodiment of the detachable multiaxial aircraft.

FIG. 12 is a schematic view of a fourth exemplary embodiment of a detachable multiaxial aircraft.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale, and the proportions of certain parts may be exaggerated better illustrate details and features. The description is not to considered as limiting the scope of the exemplary embodiments described herein.

Several definitions that apply throughout this disclosure will now be presented. The terms “connected” and “coupled” are defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like. It should be noted that references to “an” or “one” exemplary embodiment in this disclosure are not necessarily to the same exemplary embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

References will now be made to the drawings to describe, in detail, various exemplary embodiments of the present detachable multiaxial aircrafts.

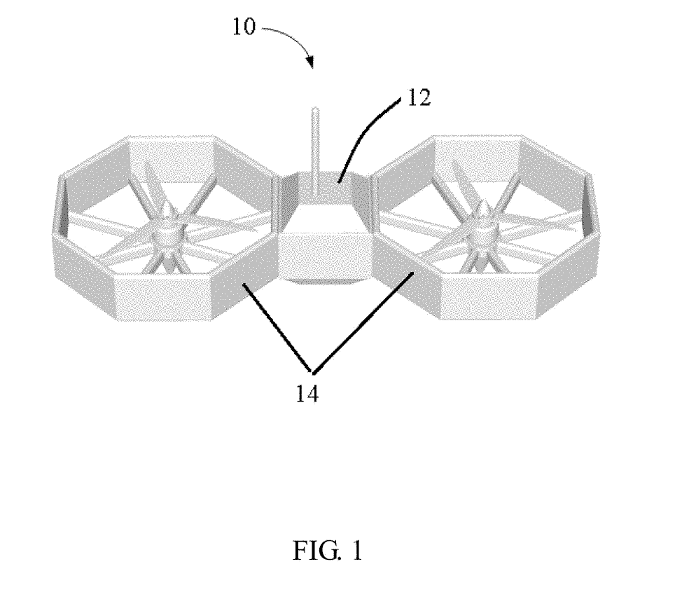

FIG. 1 illustrates a first exemplary embodiment of a detachable multiaxial aircraft 10. The detachable multiaxial aircraft 10 includes a fuselage 12 and two lift arm assemblies 14. The two lift arm assemblies 14 are detachably connected to the fuselage 12. The “detachably” can be realized by a plug-in method or a magnetic attraction method. The two lift arm assemblies 14 can be electrically connected to the fuselage 12 by wire or wireless, e.g. bluetooth, infrared, Wifi or RFID. The two lift arm assemblies 14 are located on two opposite sides of the fuselage 12 to form a biaxial aircraft.

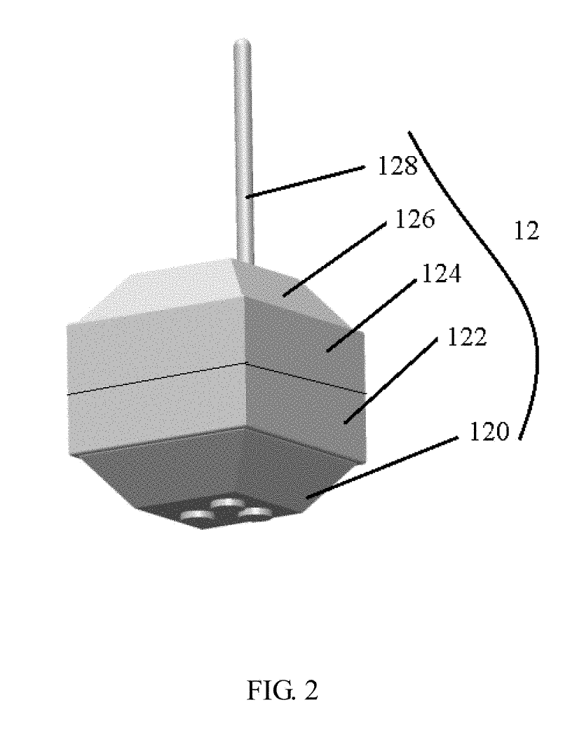

Referring to FIG. 2, the fuselage 12 includes a positioning module 120, an actuating module 122, a flying controlling module 124, and a communication module 126. The communication module 126 can include an external antenna 128 or an internal antenna (not shown).

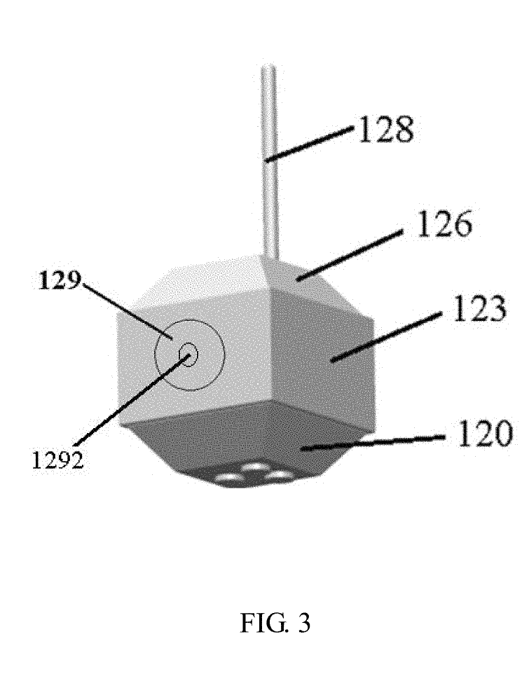

In one embodiment, each of the positioning module 120, the actuating module 122, the flying controlling module 124, and the communication module 126 can include an electromagnetic shield casing, a hardware located in the electromagnetic shield casing, and software loaded on the hardware. The hardware can be an electronic compass, a gyroscope, an accelerometer, a control circuit, a micro computer, or a battery. The positioning module 120, the actuating module 122, the flying controlling module 124, and the communication module 126 can be detachably assembled together in operation. Thus, the electromagnetic interference between any two of the positioning module 120, the actuating module 122, the flying controlling module 124, and the communication module 126 can be decreased. Moreover, each of the positioning module 120, the actuating module 122, the flying controlling module 124, and the communication module 126 can be replaced individually. In one embodiment, some or all of the positioning module 120, the actuating module 122, the flying controlling module 124, and the communication module 126 can share the same electromagnetic shield casing. As shown in FIG. 3, the actuating module 122 and the flying controlling module 124 share the same electromagnetic shield casing and together form a central module 123. The electromagnetic shield casing of the central module 123 can have a cross section in the shape of square, rectangle, regular hexagon, or regular octagon.

In one embodiment, the flying controlling module 124 includes a first cuboid electromagnetic shield casing, the actuating module 122 includes a second cuboid electromagnetic shield casing. The first cuboid electromagnetic shield casing and the second cuboid electromagnetic shield casing have the same cross section so that the first cuboid electromagnetic shield casing and the second cuboid electromagnetic shield casing can form a third cuboid electromagnetic shield casing by stacking with each other. In operation, the flying controlling module 124 and the actuating module 122 are detachably assembled together to form the central module 123. The central module 123 includes the third cuboid electromagnetic shield casing. The third cuboid electromagnetic shield casing includes four same first side walls connected and perpendicular to each other. The communication module 126 includes a first truncated trapezoid cone shaped electromagnetic shield casing, and the positioning module 120 includes a second truncated trapezoid cone shaped electromagnetic shield casing. The first truncated trapezoid cone shaped electromagnetic shield casing has a bottom wall same as the top wall of the third cuboid electromagnetic shield casing of the central module 123. The second truncated trapezoid cone shaped electromagnetic shield casing has a top wall same as the bottom wall of the third cuboid electromagnetic shield casing of the central module 123. In operation, the communication module 126 is detachably connected to the top wall of the central module 123, and the positioning module 120 is detachably connected to the bottom wall of the central module 123. In one embodiment, each of the electromagnetic shield casings includes a first bulge corresponding to a second blind hole of another electromagnetic shield casing and a first blind hole corresponding to a second bulge of another electromagnetic shield casing. Metal pads are located on the top of the bulges and the bottom of the blind holes.

As shown in FIG. 3, the fuselage 12 includes two first connectors 129 located on at least two opposite side surfaces of the central module 123. The two first connectors 129 are used to detachably connect with the lift arm assembly 14. The first connectors 129 can further include a first metal pad 1292. The first connector 129 can be a bulge, a blind hole, or a magnetic disc. In one embodiment, the first connector 129 includes a ring shaped magnetic disc and the first metal pad 1292 is a round metal sheet located in the central hole of the ring shaped magnetic disc.

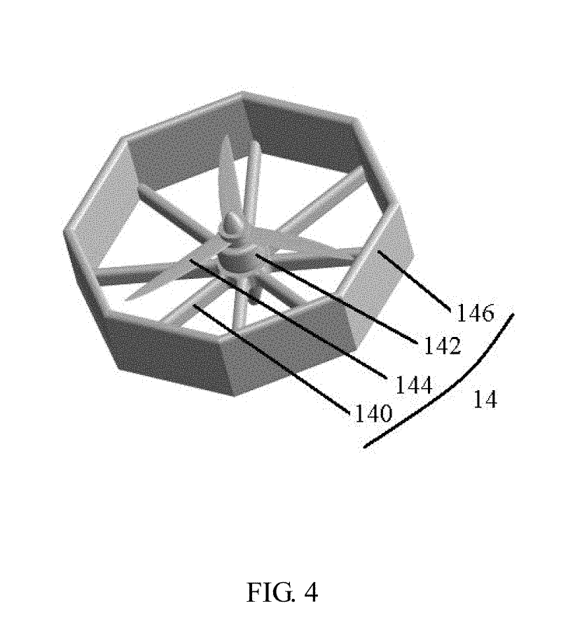

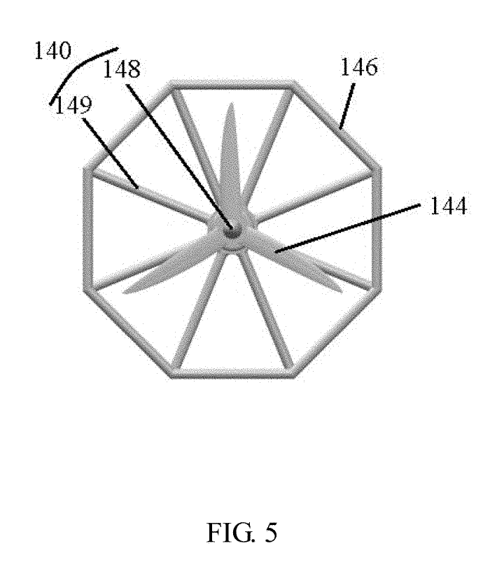

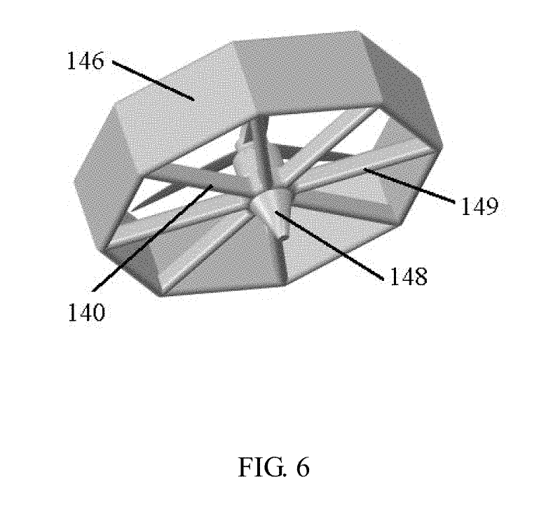

Referring to FIGS. 4-7, the lift arm assembly 14 includes a landing chassis 140, an electric motor 142 mounted on the landing chassis 140, a propeller 144 fixed on the electric motor 142, and a shell 146 located on the landing chassis 140 and surrounding the propeller 144. The structures of the landing chassis 140, the electric motor 142, and the propeller 144 are not limited and can be designed as needed. In one embodiment, the shell 146 surrounds both the propeller 144 and the electric motor 142. The landing chassis 140 and the shell 146 can be made of metal or polymer. The landing chassis 140 and the shell 146 can be an integrated structure formed by casting method. The shell 146 can have a cross section in the shape of square, rectangle, regular hexagon, or regular octagon.

In one embodiment, the shell 146 includes eight same second side walls connected to each other to form a regular octagon shaped tube. The second side wall of the shell 146 has the same shape and size as the first side wall of the central module 123. Both the first side wall and the second side wall are rectangular.

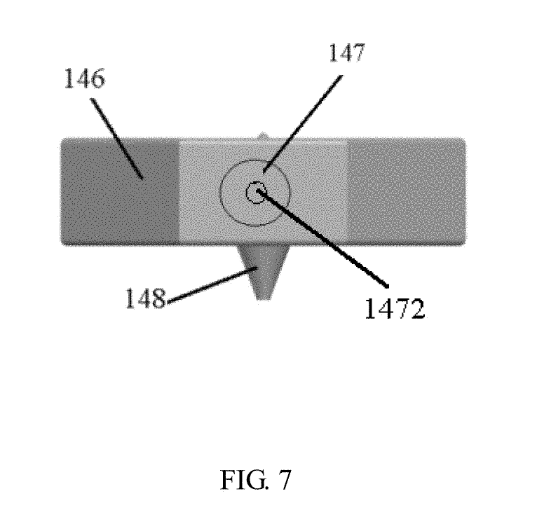

As shown in FIG. 7, the lift arm assembly 14 includes a second connector 147 located on an outer side surface of the shell 146. Thus, the lift arm assembly 14 can be detachably connected to the fuselage 12 by the first connector 129 and the second connector 147. The second connector 147 can also be a bulge, a blind hole, or a magnetic disc. When the first connector 129 is bulge, the second connector 147 should be blind hole so that the bulge can be inserted into and fixed by the blind hole. The second connector 147 can further include a second metal pad 1472. The lift arm assembly 14 and the fuselage 12 can be electrically connected to each other by the first metal pad 1292 and the second metal pad 1472. In one embodiment, the second connector 147 also includes a ring shaped magnetic disc and the second metal pad 1472 is a round metal sheet located in the central hole of the ring shaped magnetic disc. The first connector 129 has a N pole exposed and the second connector 147 has a S pole exposed so that the first connector 129 and the second connector 147 is attractable by one of the other.

The landing chassis 140 includes a pillar 148 and eight bars 149. Each bar 149 has a first end connected to the pillar 148 and a second end connected to the shell 146. The angle between adjacent two bars 149 is 45 degrees. In one embodiment, the eight bars 149 are located in the shell 146, and the pillar 148 has a first end located in the shell 146 and a second end extending out of the shell 146. The electric motor 142 is located on the first end of the pillar 148 and in the shell 146, and the propeller 144 is located on the electric motor 142 and in the shell 146. The second end of the pillar 148 is an inverted cone. When the detachable multiaxial aircraft 10 lands, all the second end of the pillars 148 of the lift arm assemblies 14 will touch the ground so that other parts of the detachable multiaxial aircraft 10 can be supported by the pillars 148. The electric motor 142 can be a three phase brushless motor, and the propeller 144 can be a trifolium self locking paddle.

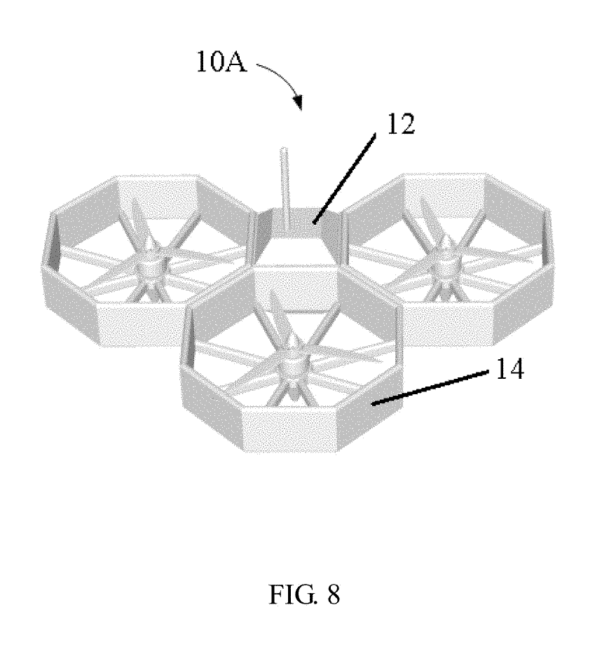

FIG. 8 illustrates a second exemplary embodiment of a detachable multiaxial aircraft 10A. The detachable multiaxial aircraft 10A includes a fuselage 12 and three lift arm assemblies 14. The three lift arm assemblies 14 are detachably connected to the fuselage 12. The three lift arm assemblies 14 are located on three adjacent sides of the fuselage 12 to form a three axial aircraft. The detachable multiaxial aircraft 10A of the second exemplary embodiment is similar to the detachable multiaxial aircraft 10 of the first exemplary embodiment except that the detachable multiaxial aircraft 10A includes three lift arm assemblies 14.

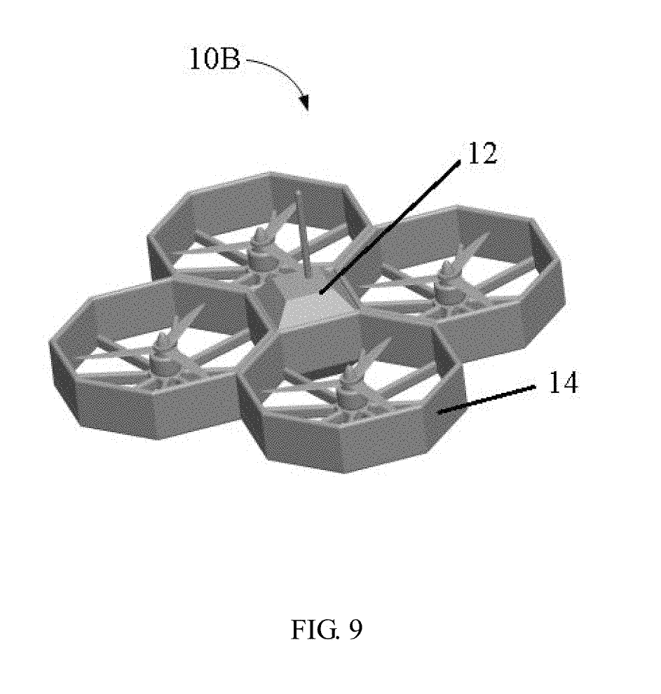

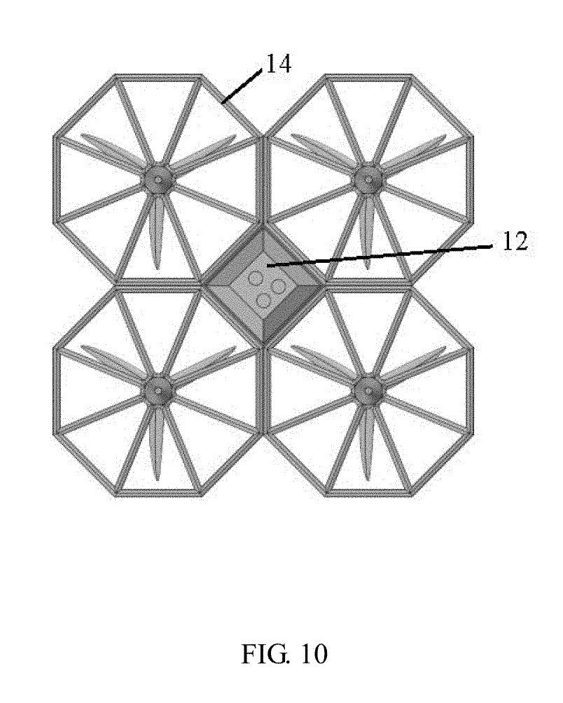

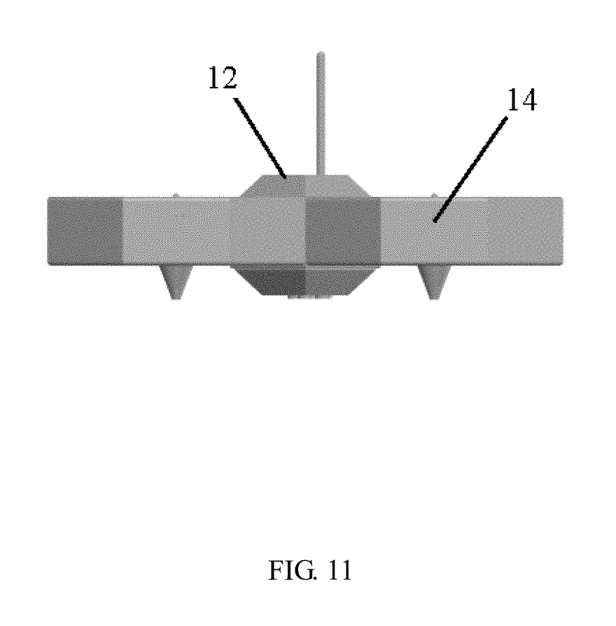

Referring to FIGS. 9-11, a detachable multiaxial aircraft 10B of the third exemplary embodiment is provided. The detachable multiaxial aircraft 10B includes a fuselage 12 and four lift arm assemblies 14. The four lift arm assemblies 14 are detachably connected to the fuselage 12. The four lift arm assemblies 14 are located on four sides of the fuselage 12 to form a cross shaped four axial aircraft. The detachable multiaxial aircraft 10B of the third exemplary embodiment is similar to the detachable multiaxial aircraft 10 of the first exemplary embodiment except that the detachable multiaxial aircraft 10B includes four lift arm assemblies 14. Adjacent two lift arm assemblies 14 are in direct contact with each other by overlapping the second side walls of the shell 146. Furthermore, the adjacent two lift arm assemblies 14 can be detachably connected to each other by a plug-in method or a magnetic attraction method. Thus, the detachable multiaxial aircraft 10B is stronger.

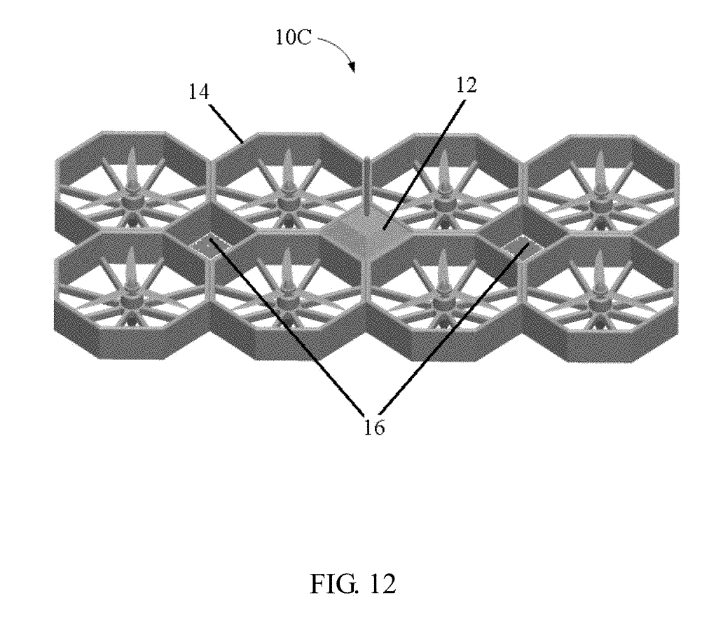

Referring to FIG. 12, a detachable multiaxial aircraft 10C of the fourth exemplary embodiment is provided. The detachable multiaxial aircraft 10C includes a fuselage 12 and eight lift arm assemblies 14. The first four of the eight lift arm assemblies 14 are directly detachably connected to the fuselage 12 and used as main lift arm assemblies. The second four of the eight lift arm assemblies 14 are directly detachably connected to the first four lift arm assemblies 14 and used as assistant lift arm assemblies. The first four lift arm assemblies 14 are directly located on four sides of the fuselage 12 to form a cross shape, and each of the second four lift arm assemblies 14 is directly detachably connected to one of the first four lift arm assemblies 14 to form an eight axial aircraft. In one embodiment, the eight lift arm assemblies 14 are arranged to form two rows. Adjacent two lift arm assemblies 14 are in direct contact with each other by overlapping the second side walls of the shell 146.

The detachable multiaxial aircraft 10C of the fourth exemplary embodiment is similar to the detachable multiaxial aircraft 10 of the first exemplary embodiment except that the detachable multiaxial aircraft 10C includes eight lift arm assemblies 14, and the lift arm assembly 14 includes at least the second connector 147 and a third connector (not shown). The third connector can also be a bulge, a blind hole, or a magnetic disc. The third connector is used to detachably connect one lift arm assembly 14 with another lift arm assembly 14. The third connector can also includes metal pad used to electrically connected to the another lift arm assembly 14. The second four lift arm assemblies 14 are electrically connected to the fuselage 12 through the first four lift arm assemblies 14. The fuselage 12 can independently control each of the eight lift arm assemblies 14. Two rooms 16 are defined by the eight lift arm assemblies 14. A spare battery (not shown) can be located in the room 16 to supply more power to the detachable multiaxial aircraft 10C.

In one embodiment, the lift arm assembly 14 includes eight connectors, and each of the eight side walls of the shell 146 has one connector. Each connector is a magnetic disc embedded in a cavity (not shown) on the side wall of the shell 146. The magnetic disc can be reversed according to need. Thus, each two adjacent lift arm assemblies 14 can be detachably connected to each other.

The biaxial aircraft can be used as toy, the four axial aircraft can be used for aerial photography, and the eight axial aircraft can be used for transport. The flying controlling module 124 can be changed according to the function of the detachable multiaxial aircrafts. Since the propeller 144 is protected by the shell 146, it is not easy to be broken. The detachable multiaxial aircrafts have a compact structure because the fuselage 12 and the lift arm assembly 14 are detachably connected to each other via the shell 146. The number of the lift arm assemblies 14 can be selected as needed so that the detachable multiaxial aircrafts have more function.

It is to be understood that the above-described exemplary embodiments are intended to illustrate rather than limit the disclosure. Any elements described in accordance with any exemplary embodiments is understood that they can be used in addition or substituted in other exemplary embodiments. Exemplary embodiments can also be used together. Variations may be made to the exemplary embodiments without departing from the spirit of the disclosure. The above-described exemplary embodiments illustrate the scope of the disclosure but do not restrict the scope of the disclosure.

Depending on the exemplary embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A detachable multiaxial aircraft, comprising a fuselage and a plurality of lift arm assemblies, wherein the fuselage comprises a first connector, and each of the plurality of lift arm assemblies comprises:
a landing chassis;
an electric motor mounted on the landing chassis;
a propeller mounted on the electric motor; and
a shell located on the landing chassis and surrounding the propeller, wherein the shell comprises a second connector, and each of the plurality of lift arm assemblies is detachably connected to the fuselage by the first connector and the second connector.

2. The detachable multiaxial aircraft of claim 1, wherein the shell further comprises a third connector, and adjacent two of the plurality of lift arm assemblies are detachably connected to each other by the third connector.

3. The detachable multiaxial aircraft of claim 2, wherein some of the plurality of lift arm assemblies are directly detachably connected to the fuselage by the first connector and the second connector, and the rest of the plurality of lift arm assemblies are directly detachably connected to the some of the plurality of lift arm assemblies by the third connector.

4. The detachable multiaxial aircraft of claim 3, wherein the fuselage independently control each of the plurality of lift arm assemblies.

5. The detachable multiaxial aircraft of claim 2, wherein each of the first connector, the second connector, and the third connector comprises a bulge, a blind hole, or a magnetic disc.

6. The detachable multiaxial aircraft of claim 5, wherein each of the first connector, the second connector, and the third connector comprises the magnetic disc.

7. The detachable multiaxial aircraft of claim 5, wherein each of the first connector, the second connector, and the third connector comprises a ring shaped magnetic disc and a metal pad located in a central hole of the ring shaped magnetic disc.

8. The detachable multiaxial aircraft of claim 1, wherein the fuselage comprises a electromagnetic shield casing, a hardware located in the electromagnetic shield casing, and software loaded on the hardware; the electromagnetic shield casing has a cross section in the shape of square, rectangle, regular hexagon, or regular octagon; and the first connector is located on an outer surface of the electromagnetic shield casing.

9. The detachable multiaxial aircraft of claim 8, wherein the electromagnetic shield casing is cuboid and comprises four first side walls connected and perpendicular to each other.

10. The detachable multiaxial aircraft of claim 9, wherein the shell comprises eight second side walls connected to each other to form a regular octagon shaped tube, and each of the eight second side walls has the same shape and size as each of the four first side wall.

11. The detachable multiaxial aircraft of claim 10, wherein the shell comprises eight second connectors, and each of the eight second side walls comprises one of the eight second connectors.

12. The detachable multiaxial aircraft of claim 1, wherein the fuselage comprises a positioning module, an actuating module, a flying controlling module, and a communication module.

13. The detachable multiaxial aircraft of claim 12, wherein each of the positioning module, the actuating module, the flying controlling module, and the communication module comprises an electromagnetic shield casing, a hardware located in the electromagnetic shield casing, and software loaded on the hardware.

14. The detachable multiaxial aircraft of claim 13, wherein the positioning module, the actuating module, the flying controlling module, and the communication module are detachably connected to each other.
